(19) United States
(12) Patent Application Publication
(10) Pub. No.: US 2008/0160874 A1
(43) Pub. Date: Jul. 3, 2008

(54) BALL-AND-SOCKET SEGMENTED MANIPULATIVE DEVICE

(75) Inventor: David E. Silverglate, Santa Cruz, CA (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: RHINO TOYS, INC., Santa Cruz, CA (US)

(21) Appl. No.: 11/964,431

(22) Filed: Dec. 26, 2007

Related U.S. Application Data
(60) Provisional application No. 60/877,563, filed on Dec. 27, 2006.

(51) Int. Cl. F16C 11/06; A63H 33/08

(52) U.S. Cl. 446/124; 403/90

(57) ABSTRACT

A device for manipulation by hands of a user is provided. The device comprises a plurality of segments, each segment including a ball, a socket having a wall that at least partially defines a spherical hollow, and a connecting arm formed between the ball and socket wherein the connecting arm is attached to each of the ball and the socket at respective positions, at least one of the positions being offset from a longitudinal axis extending through a center of the ball and a center of the spherical hollow wherein the plurality of segments are arranged to include pairs of adjoining segments that are releasably interconnected to each other by ball-and-socket joints formed by the interconnection of a ball of a first segment and a socket of a second segment of the pair.

### CROSS-REFERENCE TO RELATED APPLICATIONS

This application claims priority under 35 U.S.C. §119 to U.S. Provisional Application Ser. No. 60/877,563, entitled “Ball-And-Offset-Socket, Segmented, Manipulative Device,” which was filed on Dec. 27, 2006, the entire disclosure of which is hereby incorporated by reference.

### TECHNICAL FIELD

The present disclosure relates to a manipulative device formed by a plurality of releasable interconnected segments, and more particularly to a manipulative device that can be manipulated by hands of a user.

### BACKGROUND

Toys and puzzles that stimulate hand movement can offer enjoyment and relaxation to the user. However, such prior manipulative toys and puzzles have been of complicated construction, or offer limited ranges of movement. For example, U.S. Pat. No. 5,897,417 discloses a construction system where elements have connection components for ball-to-socket or socket-to-socket connections. The ball-to-socket connection “locks” at discrete orientations when one or more detents in the interior of the socket protrude into one or more of a plurality of dimples on the ball. The construction elements have an elongated body in line between a dimpled ball at one end and a socket at the other end. The socket has two petals with a lip contour opposite of a sphere to secure a socket or a ball. Such a device suffers from the drawback that the locking action may be unpleasant to a user, and the construction is complicated and expensive to manufacture.

U.S. Pat. No. 5,897,417 discloses a device in which freedom of movement is constrained by two pedals and a straight elongated body. As a result, only a limited range of movement is achieved, which may frustrate a user of the device. Further, the construction of the device is complicated and thus manufacturing cost may be expensive.

### SUMMARY

According to one aspect of the present disclosure, a device is provided for manipulation by the hands of a user. The device comprises a plurality of segments, each segment including a ball, a socket having a wall that at least partially defines a spherical hollow, and a connecting arm formed between the ball and socket wherein the connecting arm is attached to each of the ball and the socket at respective positions, at least one of the positions being offset from a longitudinal axis extending through a center of the ball and a center of the spherical hollow. The plurality of segments are arranged to include pairs of adjoining segments that are releasably interconnected to each other by ball-and-socket joints formed by the interconnection of a ball of a first segment and a socket of a second segment of the pair. In one embodiment, the longitudinal axis extends through a center of the ball and a center of the spherical hollow.

According to another aspect of the present disclosure, a device for manipulation by hands of a user comprises a plurality of releasably interconnected segments, each segment having a ball, a socket, and a connecting arm formed between the ball and the socket, the connecting arm being attached to each of the ball and socket at respective positions that are longitudinally spaced apart and vertically offset from each other; wherein adjoining segments within the plurality of segments are connected by joints formed by the coupling of a ball of a first segment and a socket of a second segment of the adjoining segments.

According to yet another aspect of the present disclosure, a device for manipulation by hands of a user comprises a plurality of releasably interconnected segments, each segment having a ball, a socket, and a connecting arm formed between the ball and the socket, the socket including an integral wall with opposed side portions configured to grip a ball of an adjoining segment, the socket wall further including a first U shaped opening on a distal end of the socket and a second U shaped opening on a connecting arm side of the socket, each of the U shaped openings being sized to enable the ball-and-socket joint to have freedom of movement when the connecting arm is positioned therein, wherein the freedom of movement is only constrained by a size of the socket.

### BRIEF DESCRIPTION OF THE DRAWINGS

FIG. 1 is a plan view of an example manipulative device in a flat configuration according to one embodiment of the present disclosure.

FIG. 2A is a perspective view of an example ball-and-socket segment of the manipulative device shown in FIG. 1.

FIG. 2B is a side view of an example ball-and-socket segment of the manipulative device shown in FIG. 1.

FIG. 2C is a bottom view of an example ball-and-socket segment of the manipulative device shown in FIG. 1.

FIG. 2D is a top view of an example ball-and-socket segment of the manipulative device shown in FIG. 1.

FIG. 2E is a front view of an example ball-and-socket segment of the manipulative device shown in FIG. 1.

FIG. 3A is a top view of two attached ball-and-socket segments with the second segment bent to one side.

FIG. 3B is a top view of two attached ball-and-socket segments with the center of the ball and socket of both segments in alignment.

FIG. 3C is a top view of two attached ball-and-offset-socket segments with the second segment bent to a second side.

FIG. 4A is a side view of two attached ball-and-offset-socket segments with the center of the ball and socket of both segments in alignment.

FIG. 4B is a side view of two attached ball-and-socket segments with the second segment bent up slightly.

FIG. 4C is a side view of two attached ball-and-socket segments with the second segment bent down to a maximum extent.

FIG. 4D is a side view of two attached ball-and-socket segments with the second segment twisted along the axis shared by the balls and sockets of both segments.

FIG. 4E is a side view of two attached ball-and-socket segments with the second segment twisted 180 degrees as in FIG. 4D and then bent up to a maximum extent.

FIG. 5A is a side view of eight ball-and-socket segments arranged in a flat ring shape.

FIG. 5B is a perspective view of six ball-and-sockets arranged in an arbitrary strip.

FIG. 5C is a side view of four ball-and-offset-sockets in a compact form.

### DETAILED DESCRIPTION

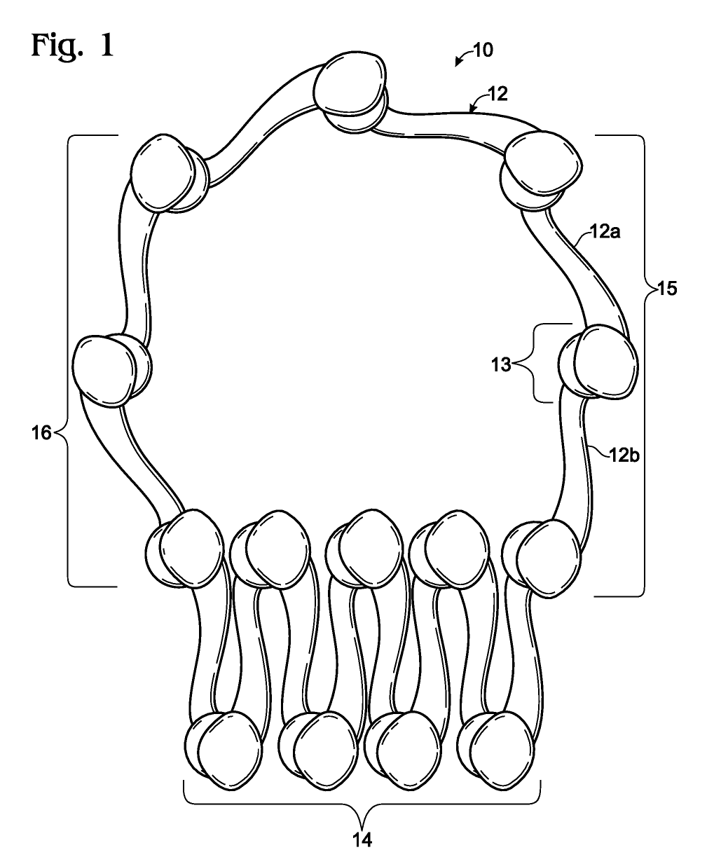

FIG. 1 is a plan view of an example manipulative device according to one embodiment. Manipulative device 10 may include a plurality of releasably interconnected segments 12 that are connected to each other by ball-and-socket joints 13. Typically, segments 12 are made of plastic and substantially rigid so as to snap fit together at the ball-and-socket joints, although it will be appreciated that other suitable materials may be used.

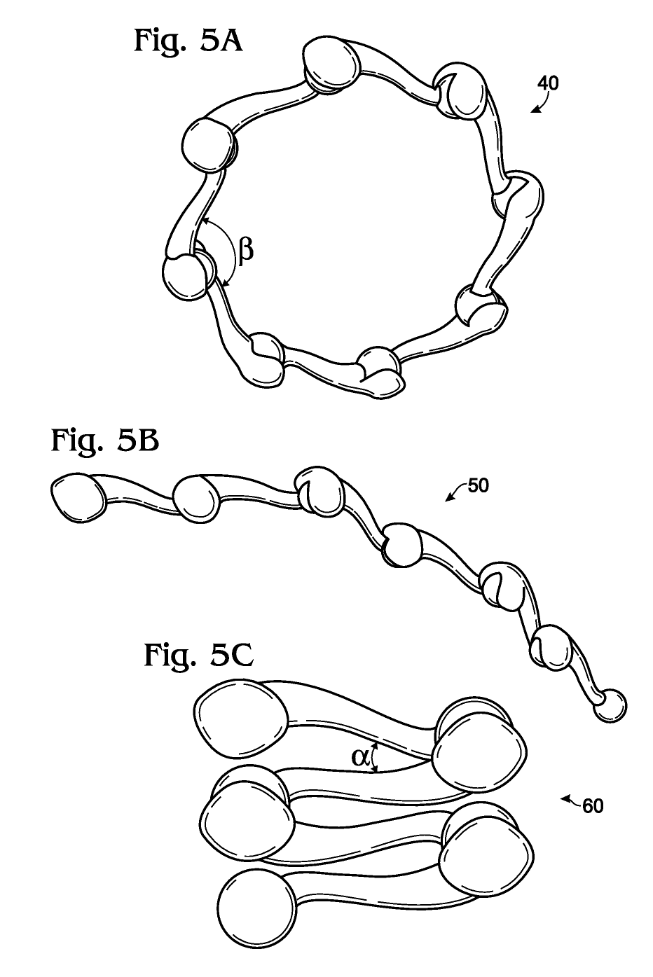

During use, the segments 12 of the manipulative device 10 may be bent and twisted into a variety of configurations, due to the freedom of movement provided by the ball-and-socket joints 13. All or a portion of the manipulative device 10 may be arranged in a folded configuration 14 that fits into a small volume, for example by bending segments in an accordion fold. Further, all or a portion of the manipulative device 10 may be arranged in a curved configuration 16, in which the segments are arranged end-to-end to arc in a curve. FIG. 5A illustrates manipulation device 10 in a curved configuration in the form of a ring, while FIG. 5B illustrates manipulation device 10 in a curved configuration in the form of an arc. Although the configurations of manipulative device 10 illustrated in the Figures are flat, it will be appreciated that any suitable spatial arrangement may be possible, and selected segments may be manipulated to position the manipulation device 10 in a three-dimensional configuration. Further, it will be appreciated that the number of segments illustrated in the Figures is merely exemplary, and that segments may be added or removed as desired, using the snap fit ball-and-socket joints. The repeated action of adjusting the device between these various configurations, snapping and unsnapping the segments, and adding and removing segments, may have the potential benefit of stimulating the hands of the user to release tension and provide exercise.

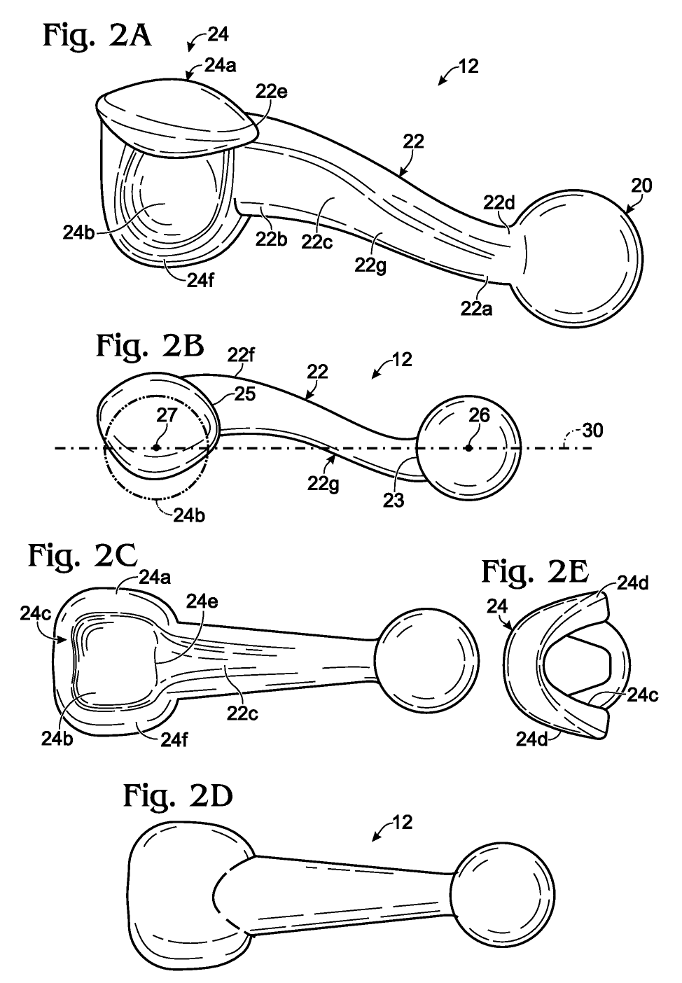

FIG. 2A is a perspective view of an example segment 12 of the manipulative device 10 shown in FIG. 1. As shown in FIG. 2A, each segment 12 may include a ball 20, a socket 24, and a connecting arm 22 formed between the ball 20 and the socket 24. The socket 24 may have a socket wall 24a that at least partially defines a spherical hollow 24b. The connecting arm 22 is typically attached to each of the ball 20 and the socket 24 at respective positions 23 and 25, at least one of which positions is offset from a longitudinal axis 30 extending through a center 26 of the ball 20 and a center 27 of the spherical hollow 24b. When interconnected, the plurality of segments 12 of the manipulation device 10 are arranged to include pairs 15 of adjoining segments 12 that are releasably interconnected to each other by ball-and-socket joints 13 formed by the interconnection of a ball 20 of a first segment 12a and a socket 24 of a second segment 12b of the pair 15.

Turning now to the structure of socket 24, socket 24 may include a socket wall 24a that at least partially defines a spherical hollow 24b configured to receive a ball of an adjoining segment. As shown in FIGS. 2A and 2C, socket wall 24a may include a continuous edge 24f Further, socket wall 24a may be configured to have a first U-shaped opening 24c on a distal end of the socket and a second U-shaped opening 24e positioned on a connecting arm side of the socket. The first and second U-shaped openings 24c, 24e may be sized to fit connecting arm 22 of an adjoining segment and to permit movement of the adjoining segment at the socket when the connecting arm is positioned therein.

Further, as shown in FIG. 2E, socket wall 24a may include a pair of opposed side portions 24d configured to grip the ball of an adjoining segment from opposite sides to thereby releasably secure the ball in the socket. As shown in FIG. 2A, the socket wall 24a may be integrally formed around at least a portion of the spherical hollow 24b. The edge 24f may extend around a circumference of the wall, and may undulate to define the opposed side portions 24d and the first and second U-Shaped openings 24c, 24e. Socket wall 24a may be positioned on one side of hollow 24b such that the freedom of movement of the adjoining segment is not overly constrained. Thus, in the depicted embodiment, socket wall 24a is positioned above longitudinal axis 30 on a top side of the spherical hollow 24b.

Turning to structure of connecting arm, connecting arm 22 may be configured in a suitable configuration to permit freedom of motion between interconnected segments. For example, connecting arm 22 may include a ball end 22a and a socket end 22b, the ball end 22a being connected to the ball 22 by a ball interface region 22d. Connecting arm 22 further may include a socket interface region 22e, which is formed at the intersection of connecting arm 22 and socket 24. As illustrated, socket interface region 22e is typically a sharp edge, but may also include a radiused curve.

Connecting arm 22 may be attached to ball 20 and socket 24 at respective positions 23 and 25. In some embodiments, connecting arm 22 is offset from a longitudinal axis 30. In the depicted embodiment, as shown in the side view of segment 12 in FIG. 2B, longitudinal axis 30 extends through a center 26 of ball 20 and a center 27 of the hollow 24b. Further, as shown in FIG. 2B, a portion of connecting arm 22 adjacent to socket 24 and a portion of connection arm 22 adjacent to ball 20 are offset from longitudinal axis 30. Thus, in the depicted embodiment, position 25 at the socket end 22b and position 23 at the ball end 22a of connecting arm 22 may be above and below longitudinal axis 30, respectively. In some embodiments, only the portion of connecting arm 22 adjacent to socket 24 may be offset from longitudinal axis 30. Alternatively, only the portion of connecting arm 22 adjacent to ball 20 may be offset from longitudinal axis 30. In addition, although the positions 23, 25 are shown on opposite sides of the longitudinal axis 30, it will be appreciated that in some embodiments the positions 23, 25 may be on the same side of longitudinal axis 30.

In some embodiments, connecting arm 22 may be formed in a contoured shape. For example, as viewed from the side of segment 12 in FIG. 2B, a top side 22f of connecting arm 22 includes a concave portion adjacent to ball end 22a and a convex portion adjacent to socket end 22b. Further, a bottom side 22g includes a concave portion adjacent socket end 22b and a convex portion adjacent the ball end 22a. Further, as described above, connecting arm 22 adjacent to socket end 22b may be positioned above longitudinal axis 30 and connecting arm 22 adjacent to ball end 22a may be positioned below longitudinal axis 30, i.e., one or more of the end portions of connecting arm 22 may be offset relative to longitudinal axis 30.

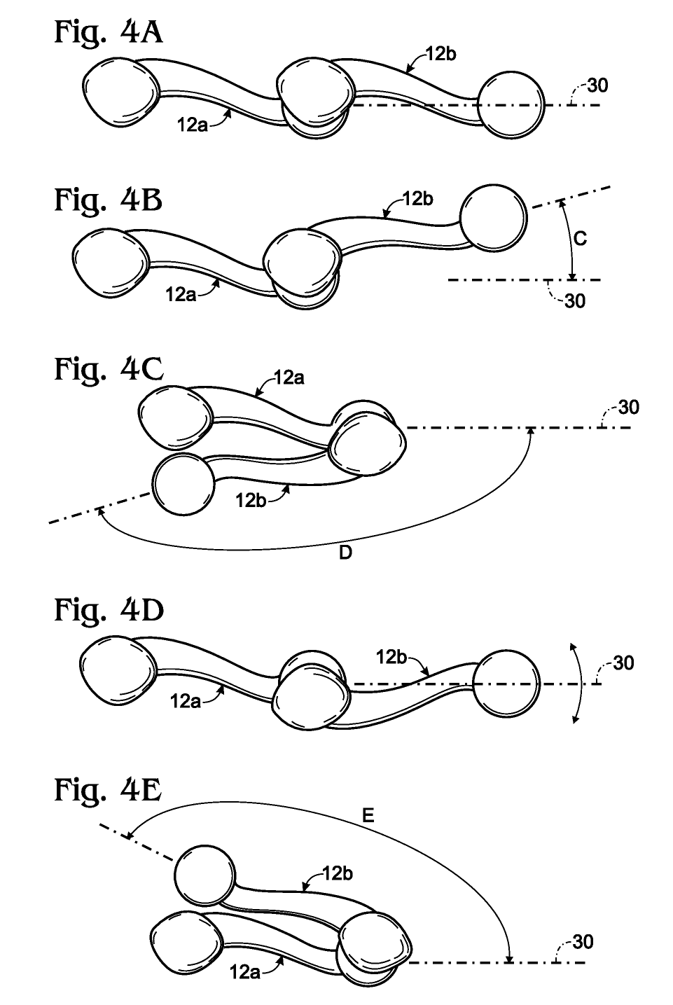

Further, as shown in FIGS. 2A and 2C, a lateral concavity 22c may be formed on a bottom side 22g of connecting arm 22. In the depicted embodiment, concavity 22c is adjacent to socket end 22b and follows the concaved shape of top side 22f It will be appreciated that the shape of lateral concavity 22c allows for greater freedom of movement, for example, when the top side 22f of a connecting arm of an adjacent segment is positioned in the concavity 22c, as shown in FIG. 4C.

Further, connecting arm 22 may be tapered as viewed from the top side 22f or from the bottom side 22g. As shown by the bottom and top views in FIG. 2C and FIG. 2D, the width of connecting arm 22 may increase from a narrow end adjacent to ball 22 to a wide end adjacent to socket 24. Further, the width of connecting arm 22 may be sized such that the narrow end of one segment accommodates the wide concaved end of an adjoining segment when the two segments are folded together. The accommodation between two adjoining segments allows the two segments to fit into a compact space defined by a nearly rectangular shape. Alternatively, it will be appreciated that the connecting arm may have a width that is constant over a length of connecting arm 22.

Ball 20 and socket 24 may be configured such that ball 20 and socket 24 can be easily snapped and released while sufficient force or friction is maintained at the ball-and-socket joint to allow the segments to remain in a desired arrangement. Meanwhile, socket 24 may be configured or sized to minimize the constriction of the movement of adjoining segments as described above.

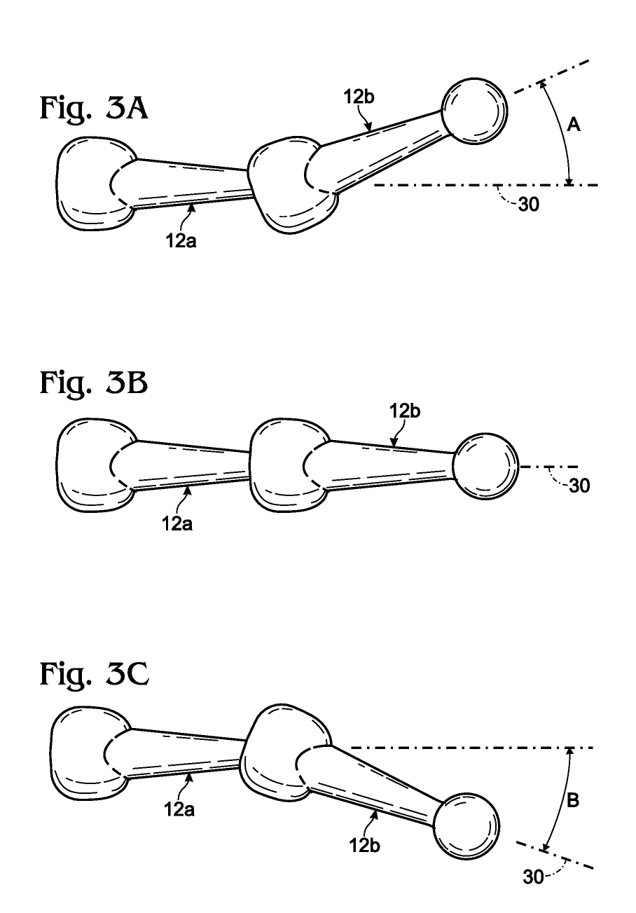

FIGS. 3A-3C are top views of a pair of adjoining interconnected ball-and-socket segments 12 at different angles, with a first segment 12a shown adjacent a second segment 12b. It will be appreciated that the range of movement illustrated in FIGS. 3A-3C is provided by the interaction between the ball end 22a of the connecting arm on the first segment 12a and the distal U-shaped opening on the second segment 12b.

FIG. 3A shows that from a coaxial face-aligned orientation, the second segment can move to angle A from longitudinal axis 30 in one direction when the ball of the second segment moves toward a side of the socket of the first segment as viewed from a top of the segments. FIG. 3C shows that from the coaxial face-aligned orientation, the second segment can be moved to angle B from longitudinal axis 30 in an opposite direction when the ball of the second segment moves toward a side of the socket of the first segment as viewed from a top of the segments. Contacts between the ball end of the connecting arm of the segment 12a and the edge of the socket wall of the segment 12b limit the rotational freedom of movement in the plane FIGS. 3A and 3C to the depicted range of degrees. In some embodiments, the opposed side portions 24d of socket wall 24a are symmetric. Thus, angle A may be equal to angle B. For example, in the depicted embodiment, angles A and B are approximately 20 degrees. Alternatively, the side portions 24d may not be symmetric and the angle A and angle B may differ. Further, it will be appreciated that the U-shaped opening (e.g., 24c as illustrated in FIGS. 2C and 2E) of the segment 12b may be widened or narrowed, or alternatively or in combination the width of the ball end 22a of the connecting arm of segment 12a may be suitably varied, to alter this range.

FIGS. 4A-4E are side views of a pair of adjoining interconnected ball-and-socket segments at different angles, with a first segment 12a shown adjacent a second segment 12b. FIG. 4A illustrates the coaxial face-aligned orientation, also shown in FIG. 3B, wherein centers of both balls 20 and sockets 24 of the first segment 12a and the second segment 12b are coaxially aligned along longitudinal axis 30.

FIG. 4B. shows, from the coaxial face-aligned orientation, that second segment 12b can be moved to an angle C. In the depicted embodiment, the angle C is approximately 20 degree from the longitudinal axis in a direction when the ball of the first segment moves toward a back of the socket of the second segment as viewed from a side of segments. Contacts between a central portion of the edge 24f of a socket wall 24a of segment 12b and a ball end 22a of the connecting arm 22 of segment 12a constrain the upward rotational movement in this orientation. It will be appreciated that these structures may be suitably modified to provide greater or lesser rotational movement upward if so desired.

FIG. 4C shows, from the coaxial face-aligned orientation, that second segment 12b can be moved to a wide angle D from the longitudinal axis 30 in a direction when the ball of second segment 12b moves toward a hollow of the socket of first segment 12a as viewed from a side of segments. In the depicted embodiment, the angle D is approximately 160 degrees. Contact between a ball of segment 12b and an edge 24f of a socket wall of segment 12a and also contact between the ball end of the segment 12b and the socket end of the segment 12a constrain the rotational movement in this position. It will be appreciated that these structures may be suitably modified to provide greater or lesser rotational movement if so desired.

FIG. 4D shows that the ball-and-socket joint may be configured such that first segment 12a and second segment 12b are capable of being aligned in a coaxial face-opposite orientation. In the coaxial face-opposite orientation wherein centers of both balls and sockets of first segment 12a and second segment 12b are aligned along longitudinal axis 30, and both first and second segments are in a plane containing both segments, and an opening of each socket faces an opposite direction. It will be appreciated from this orientation that a ball 20 of the first segment 12a is free to rotate 360 degrees in a socket of second segment 12b around longitudinal axis 30.

FIG. 4E shows that the second segment 12b may be moved to an angle E from the longitudinal axis in a direction when the ball of second segment 12b moves toward a back of the socket of the adjoining segment in the coaxial opposite facing orientation as viewed from the side of the segments. In the depicted embodiment, the angle E is approximately 160 degrees. Rotational motion in the vertical direction in this orientation is constrained by contact between a top side of a ball end 22a of a connecting arm 22 of second segment 12b, and a top side 22f of a socket end 22b of a connecting arm 22 of first segment 12a.

As described above, manipulative device 10 enables great freedom of movement between adjoining segments. The second segment can move within nearly the entire sphere of possible positions or almost 4 pi steradians with constraints as described above. Thus, manipulative device 10 may be manipulated into any virtually desired geometric configuration.

FIGS. 5A, 5B, and 5C show examples of geometric configurations of the manipulative device 10. FIG. 5A is a side view of eight ball-and-socket segments arranged in the shape of a flat ring 40. As described above, the ball-and-socket joints of the present disclosure allows for a great freedom of movement between two adjoining segments. For example, a degree P is greater than 90 degrees. Furthermore, ring 40 may be manipulated to have three-dimensional structure with selected segments rising from the flat plane. Ring 40 may be arranged in a nearly round-shape, for example, to be worn as a bracelet. Alternatively, ring 40 may be used as a decoration.

FIG. 5B is a perspective view of six ball-and-socket segments arranged in an arc 50, with the ends uncoupled. It will be appreciated that segments 12 can be bent or twisted to follow virtually any desired curve or line. The variety of possible configurations may keep a user's interest and provide entertainment, stimulation and relaxation, without tedium.

FIG. 5C is a side view of four ball-and-socket segments arranged in a compact form. In the depicted configuration, the segments are folded together in the configuration shown in FIGS. 4C and 4E, that is, in an accordion-like configuration. A large number of segments arranged in this manner allows the manipulative device to easily collapse and fit in a small space, such as a user's pocket or small box for storage.

It will be appreciated that any suitable number of segments may be included in the manipulative device to provide a wide range of configurations. In the depicted embodiment, the segments are like in size and shape, thereby reducing the number of molds required for manufacture and reducing manufacturing costs. However, it should be appreciated that the segments of the manipulative device may have different sizes and shapes. For example, some segments may include longer connecting arms or different diameter sockets and balls than other segments.

In the embodiment shown above, each segment is made of plastic molded in a single solid piece. In some embodiments, the plurality of segments may be precisely manufactured to ensure that the friction forces required to move or pivot segment pairs are sufficiently high to enable the manipulation device to retain its configuration when set down by a user, rather than loosely collapse. Further, the segments may be manufactured such that the force required to snap or unsnap a pair of segments may be substantially the same for all segment pairs, for continuity in feeling when manipulating the device.

Alternatively, it should be noted that the components of the segment may be made separately. For example, the ball, connecting arm and socket may be made individually and then fastened, plastically welded, or bonded together to form a single segment. Further, it should be appreciated that other suitable materials may be used for all or a portion of the segments, such as rubber, wood, ceramic, metal, etc. Furthermore, the segments of the manipulative device may be of the same color or the segments may be of different colors, for visual impact.

As described above, the manipulative device of the present disclosure has various advantages. For example, the offset arm of the ball-and-socket segments provides improved flexibility for the manipulation of the device. In some orientations, the freedom of movement of one segment is not constrained by its arm and the arm of an adjoining segment because the offset arms of a pair of segments can accommodate each other to maximize interconnecting positions available for the device. Further, with the offset, the concave and convex portions as well as width of the arm can be configured accordingly to have minimized dimensions while still maintaining sufficient structural integrity for each segment, thereby reducing movement constraints due to contact with other segments, thus permitting greater flexibility for manipulating segments.

It will be appreciated that the manipulative device may be used by children as a toy or may be used by adults for entertaining and relaxation purposes. For both children and adults alike, reconfiguring, adding, and removing of segments may stimulate and exercise the hands of a user. Additionally, the manipulative device can offer the user a therapeutic effect through hand exercise and relaxation. Hand action coupled with a low attention requirement can have a tranquilizing effect. Thus, the bending and twisting of the manipulative device can be a simple, thoughtless procedure, which produces unlimited fascinating and unpredictable configurations. With each bend and twist of the segments, the manipulative device undergoes a transformation in shape and form without repetition. The finished configuration of the manipulative device may be displayed as a stationary artistic sculpture without change and may contribute to a relaxing atmosphere, thereby providing a desirable therapeutic effect.

Further, use of an integral socket wall with U-shaped openings in the segments enables the ball-and-socket joint to have a great freedom of movement with an economy of material, while still securely retaining the ball in the socket. Furthermore, the integral socket wall may be robust against unintended decoupling and potential breakage during manipulating process when compared with a socket with a plurality of separate support to the connecting ball.

It will be appreciated that the device disclosed herein is exemplary in nature, and that these specific embodiments are not to be considered in a limiting sense, because numerous variations are possible. The subject matter of the present disclosure includes all novel and non-obvious combinations and subcombinations of the various structures, and other features, functions, and/or properties disclosed herein.

The following claims particularly point out certain combinations and subcombinations regarded as novel and nonobvious. These claims may refer to “an” element or “a first” element or the equivalent thereof Such claims should be understood to include incorporation of one or more such elements, neither requiring nor excluding two or more such elements. Other combinations and subcombinations of methods and system component configurations, processes, apparatuses, and/or other features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A device for manipulation by hands of a user, the device comprising:
a plurality of segments, each segment including:
a ball,
a socket having a wall that at least partially defines a spherical hollow, and
a connecting arm formed between the ball and socket wherein the connecting arm is attached to each of the ball and the socket at respective positions, at least one of the positions being offset from a longitudinal axis extending through a center of the ball and a center of the spherical hollow;
wherein the plurality of segments are arranged to include pairs of adjoining segments that are releasably interconnected to each other by ball-and-socket joints formed by the interconnection of a ball of a first segment and a socket of a second segment of the pair.

2. The device of claim 1, wherein the longitudinal axis extends through a center of the ball and a center of the spherical hollow.

3. The device of claim 2, wherein the connecting arm is connected to the socket at a position such that a portion of the connecting arm adjacent to the socket is offset from the longitudinal axis.

4. The device of claim 3, wherein the connecting arm is connected to the socket and the ball at respective positions above and below the longitudinal axis.

5. The device of claim 3, wherein the connecting arm includes a concave portion on a bottom side adjacent the socket end and a convex portion adjacent the ball end as viewed from a side of the segment.

6. The device of claim 5, wherein the connecting arm further includes a top side that is curved to include a concave portion adjacent the ball end and a convex portion adjacent the socket end as viewed from a side of the segment.

7. The device of claim 3, wherein the connecting arm is tapered, as viewed from above, from a wide end adjacent the socket, to a narrow end adjacent the ball.

8. The device of claim 3, wherein the connecting arm includes a lateral concavity formed in a bottom side of the connecting arm.

9. The device of claim 1, wherein each ball-and-socket joint has three degrees of freedom of movement; and wherein the wall of the socket of each ball-and-socket joint constrains angular movement of the joint.

10. The device of claim 1, wherein the wall of each socket includes a pair of opposed side portions configured to grip the ball of an adjoining segment from opposite sides, to thereby releasably secure the ball in the socket.

11. The device of claim 10, wherein each socket further includes a first U-shaped opening positioned on a distal end of the socket, the connecting arm being sized to fit within the first U-shaped opening and the first U-shaped opening being sized to permit relative movement of the ball-and-socket joint when the connecting arm is positioned therein.

12. The device of claim 11, wherein each socket further includes a second U shaped opening positioned on a connecting arm side of the socket, the connecting arm being sized to fit within the second U-shaped opening and the second U shaped opening being sized to permit relative movement of the ball-and-socket joint when the connecting arm is positioned therein.

13. The device of claim 1, wherein a ball-and-socket joint interconnecting each pair of adjoining segments is configured to be manipulated to position the adjoining segments in a coaxial face-aligned orientation wherein centers of both balls and sockets of the first segment and the second segment of the adjoining segments are coaxially aligned along the longitudinal axis, and the spherical hollows of both of the sockets face the same direction.

14. The device of claim 13, wherein the ball-and-socket joint is configured such that, from the coaxial face-aligned orientation, the second segment is capable of moving up to approximately 160 degrees from the longitudinal axis in a direction when the ball of the second segment moves toward the spherical hollow of the socket of the first segment and is capable of moving up to approximately 20 degree from the longitudinal axis in a direction when the ball of the second segment moves toward a back of the socket of the first segment as viewed from a side of segments.

15. The device of claim 14, wherein the ball-and-socket joint is configured such that, from the coaxial face-aligned orientation, the second segment is capable of moving up to approximately 20 degrees from the longitudinal axis in a direction when the ball of the second segment moves toward a side of the socket of the first segment as viewed from a top of the segments.

16. The device of claim 1, wherein the ball-and-socket joint is configured such that the adjoining segments are capable of being aligned in a coaxial face-opposite orientation, wherein centers of both balls and sockets of the first segment and the second segment are aligned along the longitudinal axis, both first and second segments are in a plane containing both segments, and an opening of each socket faces an opposite direction.

17. The device of claim 16, wherein from the coaxial face-opposite orientation, the second segment is capable of moving up to approximately 160 degrees from the longitudinal axis in a direction when the ball of the second segment moves toward a back of the socket of the adjoining segment as viewed from the side of the segments.

18. A device for manipulation by hands of a user, the device comprising:
a plurality of releasably interconnected segments, each segment having a ball, a socket, and a connecting arm formed between the ball and the socket, the connecting arm being attached to each of the ball and socket at respective positions that are longitudinally spaced apart and vertically offset from each other;
wherein adjoining segments within the plurality of segments are connected by ball-and-socket joints formed by the coupling of a ball of a first segment and a socket of a second segment of the adjoining segments.

19. A device for manipulation by hands of a user, the device comprising:
a plurality of releasably interconnected segments, each segment having a ball, a socket, and a connecting arm formed between the ball and the socket, the socket including an integral wall with a pair of opposed side portions configured to grip a ball of an adjoining segment, the socket wall further including a first U-shaped opening on a distal end of the socket and a second U-shaped opening on a connecting arm side of the socket, each of the U-shaped openings being sized to enable the ball-and-socket joint to have freedom of movement when the connecting arm is positioned therein, wherein the freedom of movement is constrained by a size of the socket wall.

20. The device of claim 19, wherein the wall is integrally formed around at least a portion of the spherical hollow, and includes an edge extending around a circumference of the wall, wherein the edge undulates to define the opposed side portions and the first and second U-Shaped openings.
